(19) United States
(12) Patent Application Publication
(10) Pub. No.: US 2026/0221797 A1
(43) Pub. Date: Jul. 30, 2026

(54) CAPACITANCE PRE-CHARGE FOR BIDIRECTIONAL SWITCHES

(71) Applicant: Infineon Technologies Austria AG, Villach (AT)

(72) Inventors: Giuseppe BERNACCHIA, Villach (AT); Roberto RIZZOLATTI, Villach (AT); Gerald Josef DEBOY, Klagenfurt (AT)

(21) Appl. No.: 19/462,570

(22) Filed: Jan. 28, 2026

Related U.S. Application Data
(60) Provisional application No. 63/751,420, filed on Jan. 30, 2025.

(51) Int. Cl. H02J 7/90; H02J 3/32

(52) U.S. Cl. CPC H02J 7/933; H02J 3/32; H02J 2207/20; H02J 2207/50

(57) ABSTRACT

Implementation of an apparatus (circuitry, system, etc.) as discussed herein includes capacitor circuitry (or other suitable energy storage entity) operative to store energy. The implemented apparatus or system as discussed herein further includes charge-discharge converter circuitry as well as a controller. The charge-discharge converter circuitry is disposed in series between a first node of a first power converter and a second node of the first power converter, where the first power converter may be operative to convert a first voltage received at the first node into a second voltage outputted from the second node. The controller is operative to: i) receive feedback associated with conversion of the first voltage into the second voltage via the first power converter, and ii) based on the received feedback, control operation of the charge-discharge circuitry to switch between charging the capacitor circuitry and discharging the capacitor circuitry.

### RELATED APPLICATION

This application claims the benefit of earlier filed United States Provisional Patent Application Serial Number 63/751,420 entitled "METHOD FOR PEAK POWER SHAVING IN DATA CENTER," (Attorney Docket No. 2025P00231US), filed on Jan. 30, 2025, the entire teachings of which are incorporated herein by this reference.

### BACKGROUND

The energy consumption for all data centers worldwide is around 2% of total energy usage. Therefore, data center providers are looking to continuously improve the efficiency of power conversion in order to save energy or to be able to increase the CPU/GPU/ASIC power per chip in existing data centers, especially since the trends of machine learning and artificial intelligent require very powerful GPUs or custom designed ASICS to cope with the need of ever more calculation power.

Nowadays, most of the digital loads are powered from a 12 V bus directly with a single stage multiphase buck topology, so called voltage regulator module (VRM). However, with the increase of power demand of the xPUs, conduction losses at the 12 V bus bar are becoming a bigger bottleneck, therefore a 48 V architecture has been implemented in recent years.

Operating the system with 40 V to 60 V input voltage bus instead of 12 V bus offers serval advantages.

In one conventional power system, a first stage of the power system converts the high input voltage down to an intermediate voltage. This first stage can be an unregulated or regulated, high-efficient and ultra-compact step down converter, a so called intermediate bus converter (a.k.a., IBC). A second stage of the power system may be based on the common buck converter, which provides very good transient response and high efficiency

Nowadays there are two possible physical locations for the IBC:

Option1: IBC being placed at tray level on a different PCB called Power Distribution Board PDB. The main advantage of such an implementation is to benefit from the lower power density required outside the AI accelerator card. The obvious drawback are however higher distribution losses on the intermediate bus converter. Furthermore IBC voltages lower than 12V are difficult to use as distribution losses will become critically limiting.

Option2: IBC placed at accelerator card level to lower distribution losses from IBC to VRM, especially when IBC is implemented with high ratio (i.e. 8:1, 10:1….). This option allows to use relatively low intermediate bus converter voltages, which in turn provide significant better switching losses at the VRM stage. The sweet-spot looking at the overall losses including first stage and second stage is around 6V, requiring hence an 8:1 divider ratio for the power conversion from 48V to Intermediate Bus voltage.

Requirements of deep learning on computation capability are constantly growing at a rate much higher than defined by Moore's law.

Prior to year 2012: Compute demand has been doubling every 2 years at the same rate as Moore’s law

Since year 2012: Compute demand has been growing 10X/year due to Deep Learning

These trends translate into an extremely large power demand. It is estimated that the annual power consumption of datacenters is in the range of 200 trillion Wh (200 x 1015 Wh). Considering that the latest generations GPUs are working at core voltages around 0.7V and may be designed for up to 1500W thermal power dissipation, load currents have reached a level of 2000A per chip and more. Moreover, the large current is accompanied by very large current transients due to the internal behavior of the GPU.

A typical power consumption profile may include very large variations from minimum current consumption to maximum current consumption as well as may include a complex envelope of the current profile.

Beside the impact of such requirements on the local converters supplying the GPUs (VRM and IBC), the large transient current consumption conditions can ripple from the GPU itself all the way to the grid. In other words, when the load consumes a very high amount of power in a short time duration, this can cause a low-voltage condition on a local grid providing the input voltage. Most of datacenter operators are concerned about their impact on the local grid, to prevent causing power outages or grid instabilities.

In the past, datacenter were running on constant load 24/7 as load side management and virtualization of processor cores enabled a very smooth load profile at typically 70% of the installed power capability. With the training of complex AI algorithms, many GPUs have to be connected into one machine with very precise synchronization of operation. Many GPUs (ten thousands today, up to 1 Mio GPUs in future AI clusters) are hence now doing the same load steps simultaneously such as initializing the job, calculating and storing to memory. This leads not only to significant transient load steps but also to very challenging thermal cycling patterns, which may cause reliability issues.

Conventional peak power shaving is an energy strategy to reduce electricity consumption during high-demand, expensive periods by using stored energy (batteries), onsite generation (solar, generators), or reducing usage to avoid high utility "demand charges," thus lowering bills and easing grid strain. Conventional peak power shaving works by "shaving" the highest spikes off the electricity demand curve, typically in the morning and evening, using stored power to supplement the grid.

Certain peak power shaving solutions are typically running in a parallel branch between a given DC voltage level and a Ground potential (e.g. +48V for AI servers and –48V for telecom). These systems normally already include a Battery Back-up Unit. However, batteries cannot cope with the need for fast transient currents. As this event occurs on a time scale such as of seconds (10 to 100 times per minute), the battery lifetime would severely degrade and the batteries would live for less than a month under these conditions.

### BRIEF DESCRIPTION

This disclosure includes the observation conventional power delivery solutions are prone to failure because they are unable to provide proper power during transient power consumption conditions. As previously discussed, implementation of conventional power delivery solutions may result in negatively impacting a grid voltage due to high power transient current consumption. Techniques herein include implementing novel power systems to support better delivery of power during peak and nonpeak power consumption conditions.

More specifically, an apparatus (circuitry, system, etc.) as discussed herein can be configured to include capacitor circuitry (or other suitable energy storage entity or reservoir) operative to store energy. The apparatus or system as discussed herein further includes charge-discharge converter circuitry as well as a controller. The charge-discharge-converter circuitry may be disposed in series between a first node of a first power converter and a second node of the first power converter, where the first power converter may be operative to convert a first voltage received at the first node into a second voltage outputted from the second node. In one example, the controller is operative to: i) receive feedback associated with conversion of the first voltage into the second voltage via the first power converter, and ii) based on the received feedback, control operation of the charge-discharge circuitry to switch between charging the capacitor circuitry and/or discharging the capacitor circuitry under different circumstances.

In a further example, the feedback received by the controller indicates a magnitude of the second voltage. In response to detecting that the magnitude of the second voltage is less than a threshold level, the controller controls the discharge of the energy in the capacitor circuitry via enabling flow of first current (supplemental current) from the capacitor circuitry through the charge-discharge converter circuitry to the second node of the first power converter. The controller is further operative to: in response to detecting that the magnitude of the second voltage is less than a threshold level, control the charge-discharge converter circuitry to prevent flow of second current from the first node through the charge-discharge converter circuitry to the capacitor circuitry.

Yet further, the charge-discharge circuitry as discussed herein can be configured to include a second power converter and a third power converter disposed in series between the first node and the second node; the charge-discharge circuitry may be disposed in parallel with the first power converter. The third node connects or couples the combination of the second power converter, the third power converter, and the capacitor circuitry to each other.

In accordance with further examples, the first power converter is operative to supply non-transient power from the second node to a load during non-transient conditions of the first power converter converting the first voltage into the second voltage. The controller is further operative to control the third power converter to supply supplemental power through the second node to the load during detected transient conditions of the first power converter producing the second voltage, where the detected transient conditions include detection of at least one instance in which a magnitude of the second voltage is less than a threshold level based on an inability of the first power converter to sufficiently power to the load during the transient conditions.

In another example, the feedback indicates a magnitude of the second voltage. The controller is further operative to: in response to detecting that the magnitude of the second voltage is less than a threshold level: i) prevent flow of first current from the first node through a first portion of the charge-discharge converter circuitry to the capacitor circuitry, and ii) discharge the energy in the capacitor through a second portion of the charge-discharge converter circuitry to the second node of the first power converter.

In yet a further example, the feedback indicates a magnitude of the second voltage. The controller is further operative to: in response to detecting that the magnitude of the second voltage is less than a threshold level: i) enable a flow of first current from the first node through a first portion of the charge-discharge converter circuitry to the capacitor circuitry, and ii) discharge the energy in the capacitor through a second portion of the charge-discharge converter circuitry to the second node of the first power converter. In such an instance, the first power converter and the corresponding charge-discharge converter circuitry operate in parallel to convert the first voltage (input voltage) into a respective second voltage to power a load.

In still another example, the feedback indicates a magnitude of the second voltage. The controller is further operative to: in response to detecting that the magnitude of the second voltage is greater than a threshold level: i) prevent flow of first current from the first node through a first portion of the charge-discharge converter circuitry to the capacitor circuitry, and ii) charge the capacitor circuitry via flow of second current from the second node through a second portion of the charge-discharge converter circuitry to the capacitor circuitry.

Still further examples as discussed herein include implementing the charge-discharge converter to include a second power converter and a third power converter disposed in series between the first node and the second node. The apparatus or system as discussed herein may further include a third node directly coupling or connecting the second power converter, the third power converter, and the capacitor circuitry to each other. The controller may be configured to implement a first peak limit of conveying power or current from the first node through the second power converter and the third node to the capacitor circuitry; the controller can be configured to implement a second peak limit of conveying power or current from the capacitor circuitry through the third node and the third power converter to the second node. In one example, the second peak limit is greater than the first peak limit.

In another example, the controller is operative to control the charge-discharge converter circuitry such that: i) a first portion of a full energy storage capacity of the capacitor circuitry is reserved to store first energy received from the first node, and ii) a second portion of the full energy storage capacity of the capacitor circuitry is reserved to store second energy received from the second node. As further discussed herein, transient conditions with respect to the second voltage may be positive or negative, resulting in the need to charge and discharge the capacitor circuitry via flow of current in both directions between the capacitor circuitry and the second node through the third power converter.

It is further noted that the energy stored in the capacitor circuitry produces a third voltage. The controller as discussed herein is further operative to control the charge-discharge converter circuitry to regulate a magnitude of the third voltage based on a combination of the first voltage, the second voltage, and the third voltage.

Still further, the controller as discussed herein is further operative to: for a first duration of time, in response to detecting that the magnitude of the second voltage is greater than a first threshold level, control operation of the charge-discharge converter circuitry to convey first current from the second node to the capacitor circuitry; and for a second duration of time occurring subsequent to the first duration of time, in response to detecting that the magnitude of the second voltage is less than a second threshold level, control operation of the charge-discharge converter circuitry to convey second current from the capacitor circuitry to the second node.

In yet further examples, the controller is further operative to: for a first duration of time, in response to detecting that a magnitude of the first voltage is greater than a first threshold level, control operation of the charge-discharge converter circuitry to convey first current from the first node to the capacitor circuitry; and for a second duration of time occurring subsequent to the first duration of time, in response to detecting that the magnitude of the first voltage is less than a second threshold level, control operation of the charge-discharge converter circuitry to convey second current from the capacitor circuitry to the first node.

Further examples as discussed herein include a method comprising: controlling operation of charge-discharge converter circuitry, the charge-discharge converter circuitry disposed in series with capacitor circuitry between a first node of a first power converter and a second node of the first power converter, the first power converter operative to convert a first voltage received at the first node into a second voltage outputted from the second node; receiving feedback associated with conversion of the first voltage into the second voltage via the first power converter; and based on the received feedback, switching the operation of the charge-discharge converter circuitry between charging the capacitor circuitry and discharging the capacitor circuitry.

In one example, switching the operation of the charge-discharge converter circuitry includes: in response to detecting that a magnitude of the second voltage is less than a first threshold level, control the charge-discharge converter circuitry to convey first current from the capacitor circuitry through the charge-discharge converter circuitry to the second node of the first power converter.

In another example, switching the operation of the charge-discharge converter circuitry includes: in response to detecting that the magnitude of the second voltage is greater than a second threshold level, controlling the charge-discharge converter circuitry to convey second current from the second node through the charge-discharge converter circuitry to the capacitor circuitry.

In still further examples as discussed herein, switching the operation of the charge-discharge converter circuitry includes: implementing a first peak limit of conveying first current from the first node through a first portion of the charge-discharge converter circuitry to the capacitor circuitry; implementing a second peak limit of conveying second current from the capacitor circuitry through a second portion of the charge-discharge converter circuitry to the second node, the second peak limit being greater than the first peak limit.

Yet further, as previously discussed, the energy stored in the capacitor circuitry produces a third voltage; and where switching the operation of the charge-discharge converter circuitry includes: controlling a magnitude of the third voltage based at least in part on a magnitude of the first voltage and a magnitude of the second voltage.

Note that any of the resources as discussed herein may include one or more computerized devices, computers, controllers, power converters, etc., or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including computer readable hardware storage or medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that support operations as discussed herein.

One example as discussed herein computer readable storage hardware and/or system having instructions stored thereon to facilitate power management. The instructions, when executed by computer processor hardware, cause the computer processor hardware (such as one or more co-located or disparately processor devices) to: control operation of charge-discharge converter circuitry, the charge-discharge converter circuitry disposed in series between a first node of a first power converter and a second node of the first power converter, the first power converter operative to convert a first voltage received at the first node into a second voltage outputted from the second node; receive feedback associated with conversion of the first voltage into the second voltage via the first power converter; and based on the received feedback, switch the operation of the charge-discharge converter circuitry between charging the capacitor circuitry and discharging the capacitor circuitry.

The ordering of the steps above has been added for clarity sake. Note that any of the processing operations as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be implemented strictly as a software program, firmware, as a hybrid of software, hardware and/or firmware, or as hardware alone such as within a processor (hardware or software), or within an operating system or a within a software application.

As discussed herein, techniques herein are well suited for use in the field of power management via implementation of large banks of capacitor circuitry to store power and corresponding charge-discharge circuitry to control the flow of power to/from the capacitor circuitry. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present examples as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating implementation of charge-discharge circuitry to support power shaving operations as discussed herein.

FIG. 2 is an example diagram illustrating implementation of charge-discharge circuitry and corresponding first charging converter and second discharging converter as discussed herein.

FIG. 3 is an example diagram illustrating power shaving and variations in power consumption by the load as discussed herein.

FIG. 4 is an example diagram illustrating implementation of a first bidirectional power converter in the charge-discharge circuitry as discussed herein.

FIG. 5 is an example diagram illustrating implementation of a second bidirectional power converter in the charge-discharge circuitry as discussed herein.

FIG. 6 is an example diagram illustrating discharge of energy stored in a capacitor bank based on feedback from a primary power converter during a transient current consumption condition by a respective load as discussed herein.

FIG. 7 is an example timing diagram illustrating variation in power consumption by a respective load and control of discharge circuitry in FIG. 6 as discussed herein.

FIG. 8 is an example diagram illustrating discharge of energy stored in a capacitor bank based on feedback of supplying a voltage to a load during a transient current consumption condition by the load as discussed herein.

FIG. 9 is an example timing diagram illustrating variation in power consumption by a respective load and control of discharge circuitry in FIG. 8 as discussed herein.

FIG. 10 is an example diagram illustrating control of discharge circuitry during a transient power consumption condition by a load discussed herein.

FIG. 11 is an example timing diagram illustrating control signals applied to discharge circuitry during the transient power consumption condition in FIG. 10 as discussed herein.

FIG. 12 is an example timing diagram illustrating different magnitudes of the voltage (power) stored in a capacitor bank over time as discussed herein.

FIG. 13 is an example diagram illustrating different control states as implemented by a controller to control the charge-discharge circuitry as discussed herein.

FIG. 14 is an example block diagram of a computer system for implementing any of the operations as previously discussed as discussed herein.

FIG. 15 is an example method of controlling flow of power as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

An apparatus (circuitry, system, etc.) as discussed herein includes capacitor circuitry (or other suitable energy storage entity) operative to store energy. The implemented apparatus or system as discussed herein further includes charge-discharge converter circuitry controlled by a controller. The charge-discharge converter circuitry is disposed in series between a first node of a first power converter and a second node of the first power converter, where the first power converter may be operative to convert a first voltage received at the first node into a second voltage outputted from the second node. The controller is operative to: i) receive feedback associated with conversion of the first voltage into the second voltage via the first power converter, and ii) based on the received feedback, control operation of the charge-discharge circuitry to switch between charging the capacitor circuitry and discharging the capacitor circuitry.

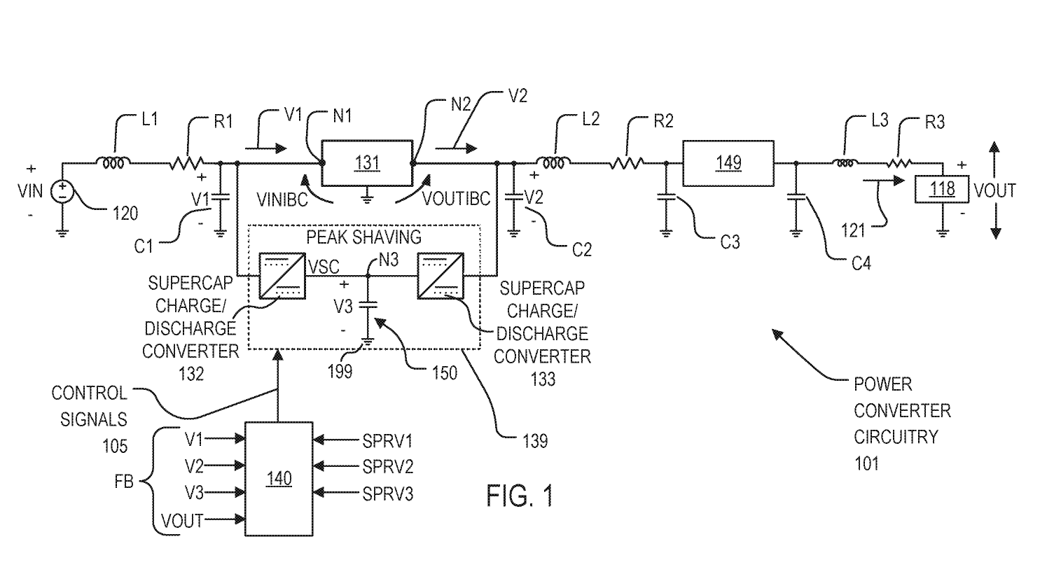

Now, more specifically, FIG. 1 is an example diagram illustrating implementation of a power distribution system as discussed herein.

In this example, the power converter circuitry 101 in FIG. 1 includes multiple components such as controller 140, input voltage source 120, resistor R1, capacitor C1, charge-discharge circuitry 139, power converter 131 (so-called primary power converter), capacitor C2, capacitor circuitry 150 (such as a capacitor bank or other suitable energy storage resource), inductor L2, resistor R2, capacitor C3, power converter 149, capacitor C4, inductor L3, resistor R3, and load 118.

The charge-discharge circuitry 139 includes power converter 132, power converter 133, and capacitor circuitry 150. In one example, one or more of the components or circuits as discussed herein is reference with respect to the row reference voltage 199.

The charge-discharge circuitry 139 is disposed in parallel with the power converter 131. For example, the power converter 132 is connected in series with the power converter 133 via connectivity provided by the node N3. The node N3 couples or directly connects both of the power converter 132 and the power converter 133 to the capacitor circuitry 150. Further, the power converter 132 is directly coupled to the node N1 while the power converter 133 is directly coupled to the node N2.

In general, operation of the circuitry as shown in FIG. 1 other than the charge-discharge circuitry 139 includes conversion of the input voltage supplied by the input voltage source 120 into a respective output voltage Vout supplied to the load 118. The power converter circuitry 101 includes the power converter 131 (a first power converter stage) operative to convert the voltage the one supplied to node N1 into the voltage V20 outputted from the node N2. It is noted that the downstream power converter 149 can be configured to convert the received voltage V2 into the respective output voltage Vout.

In one example, the controller 140 or other suitable entity controls operation of the power converter 131 to convert the input voltage V1 into the output voltage V2. The input voltage V1 may be an AC or DC voltage. The output voltage V2 may be a DC voltage. Accordingly, the power converter 131 may be a DC to DC voltage converter. The power converter 149 may be a DC to DC voltage converter as well.

The controller 140 or other suitable entity can be configured to regulate the magnitude of the output voltage V2 with respect to a setpoint reference voltage such that the output voltage Vout supplied to the load 118 is regulated at least in part via the power converter 131 converting the input voltage V1 into the output voltage V2. In one example, the controller 140 controls operation of the power converter 131 based on a received setpoint reference voltage SPRV2. In such an instance, the controller 140 or other suitable entity ensures that the magnitude of the output voltage V2 from the power converter 131 is substantially as programmed by the setpoint reference voltage SPRV2.

During first operating conditions, such as non-transient conditions of generating and supplying respective output current 121 and corresponding voltage Vout to the load 118, and assuming that the voltage V3 stored in the capacitor circuitry 150 is within a desired voltage range, the controller 140 is configured to deactivate the charge-discharge circuitry 139 such that no current flows through the power converter 132 in no current flows through the power converter 133.

In one example, the power converter 132 may be a so-called super charge/discharge converter controlled by the controller 140 via the control signals 105. The power converter 133 may be a so-called super charge-discharge converter controlled by the controller 140 via the control signals 105. In one example, the control signals control operation of respective switches in the charge-discharge circuitry 139 in accordance with conventional control techniques such as associated with a buck converter or other type of power converter.

As further shown, and as further discussed herein, the controller 140 can be configured to monitor feedback such as one or more of the voltage V1, the voltage V2, the voltage C3, and/or the voltage Vout, to convert the input voltage V1 into the output voltage V2 or Vout.

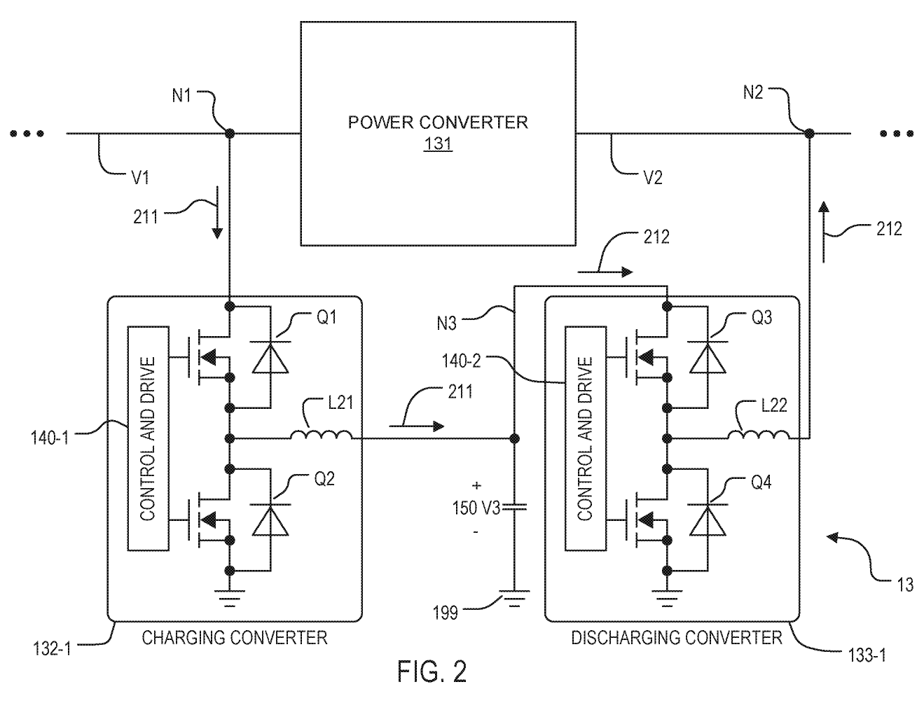

FIG. 2 is an example diagram illustrating implementation of charge-discharge circuitry and corresponding first charging converter and second discharging converter as discussed herein.

In this example, the power converter 132-1 between the node N1 and the node N3 is implemented as a so-called buck converter, where the power converter 132-1 includes control and drive circuitry 140-1, switch circuitry Q1, switch circuitry Q2, and inductor L21.

In a similar manner as previously discussed, the controller 140-1 monitors one or more parameters such as a magnitude of the voltage V1, magnitude of the voltage V2, magnitude of the voltage V3, to control operation of the power converter 132-1 and conveyance of corresponding current 211 (for example, power, energy, etc.) from the node N1 through the power converter 132-1 to the node N3 of the capacitor circuitry 150.

Further in this example, the power converter 133-1 disposed between the node N3 and the node N2 is implemented as a so-called buck converter, where the power converter 133-1 includes control and drive circuitry 140-2, switch circuitry Q3, switch circuitry Q4, and inductor L22.

In a similar manner as previously discussed, the controller 140-2 monitors one or more parameters such as a magnitude of the voltage V1, magnitude of the voltage V2, magnitude of the voltage V3, to control operation of the power converter 133-1 and conveyance of corresponding current 212 (power, energy, etc.) from the node N3 through the power converter 133-1 to the node N2.

It is noted that the power converter 132-1 and the power converter 133-1 may be simultaneously activated to convey the current 211 from the node N1 to the node N3 as well as convey the current 212 from the node N3 to the node N2.

Conversely, the power converter 132-1 and the power converter 133-1 may be simultaneously deactivated to prevent flow of any current from the node N1 through the power converter 132-1 to the node N3 as well as prevent flow of any current from the node N3 through the power converter 133-1 to the node N2.

Further, the power converter 132-1 may be activated while the power converter 133-1 is deactivated. The power converter 133-1 may be activated while the power converter 132-1 is deactivated.

In one example, as further discussed herein, such as during a non-transitory condition when the power converter 131 is able to supply sufficient power and current outputted from the node N2 to power the load 118, the power converter 132-1 may be activated in which the flow of current 211 from the node N1 and through the power converter 132-1 to the node N3 results in charging of the capacitor circuitry 150. The controller 140 can be configured to monitor a magnitude of the voltage V1 and control flow of the current 211 through the power converter 132-1 to the capacitor circuitry 150 such that the voltage V1 does not fall below a threshold level. In other words, it is desirable that the capacitor circuitry 150 store sufficient charge as a backup for generation of current 212. However, it is also desirable that the charging of the capacitor circuitry 150 does not cause the magnitude of the input voltage V1 (such as a grid voltage) to experience a low-voltage condition due to excessively high current draw.

After the capacitor circuitry 150 is charged to the appropriate level, the power converter 132-1 is deactivated. While the power converter 132-1 is deactivated, in response to detecting a condition in which the voltage V2 outputted from the power converter 131 falls below a threshold level, the controller and drive circuitry 140-2 activates the power converter 133-1 to convey current 212 from the capacitor circuitry 150 through the power converter 133-1 to the node N2.

Accordingly, energy (a.k.a., charge) can be stored in the capacitor circuitry 150 during non-transient or other conditions of supplying power to the load 118. During transient conditions in which the power converter 131 is unable to supply sufficient power or current to the load 118, the power converter 133-1 is activated to supply supplemental power (current 212) such that the magnitude of the voltage V2 does not drop below a threshold level.

Again, it is noted that implementation of the charge-discharge circuitry 139 prevents the voltage V1 from dropping below a threshold level due to excess current drawn by the power converter 131 to produce the voltage V2. In other words, in the absence of implementing the charge-discharge circuitry 139, the power converter 131 may require so much current or power input at the node N1 that the input voltage V1 drops below a threshold level. This is an undesirable condition. The circuitry as shown in FIG. 2 prevents the voltage drop (undesirable condition) via presence and implementation of the charge-discharge circuitry including the capacitor circuitry 150 (i.e., energy storage reservoir).

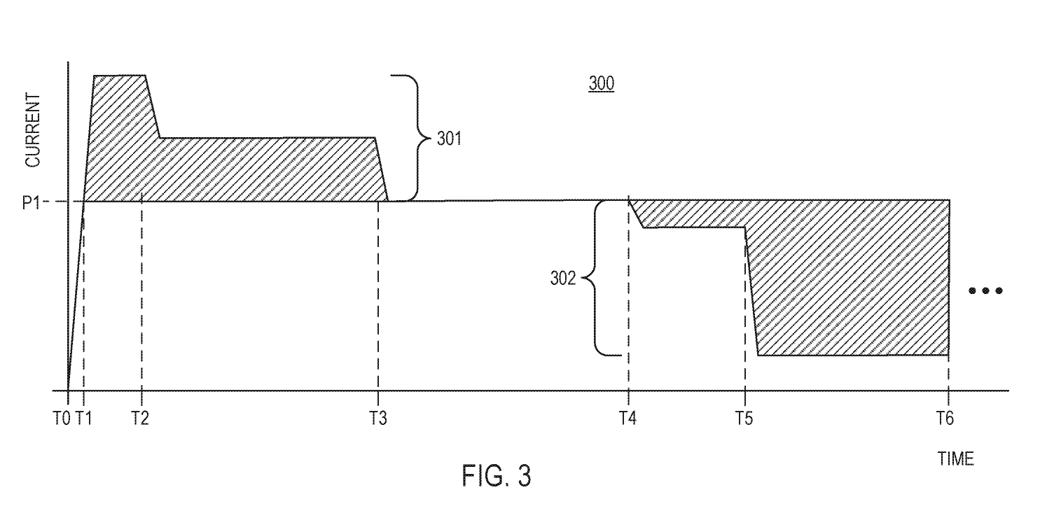

FIG. 3 is an example diagram illustrating variations in power consumption by the load as discussed herein.

In this example, the graph 300 illustrates charge and discharge of the respective capacitor circuitry 150 over time.

Assume that the load 118 consumes power level P1 between time T1 and time T4. In such an instance, the power converter 131 supplies the appropriate power to the load 118 via conversion of the input voltage V1 into the output voltage V2. Between time T1 and time T3, the power converter 132 is activated to an ON state to charge the capacitor circuitry 150 with the excess power above power level P1. After being charged to the appropriate voltage level, and storing the power or energy 301 in the capacitor circuitry 150, the power converter 132 is deactivated to an off state between time T3 and time T6.

Between time T4 and time T6, assume that the load 118 consumes more power (current) than can be provided by the power converter 131 alone. In such an instance, the controller 140 activates the power converter 133 to discharge the energy 302 stored in the capacitor circuitry 150 (such as via a flow of current 212 to the node N2) to ensure that the magnitude of the voltage V1 and the magnitude of the voltage Vout do not fall below respective threshold levels.

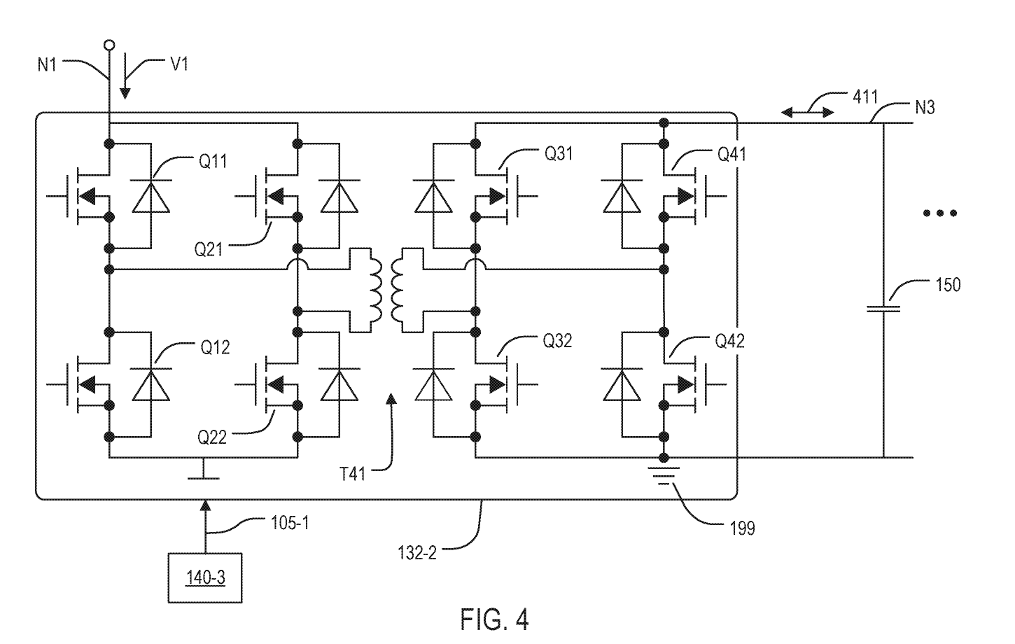

FIG. 4 is an example diagram illustrating implementation of a first bidirectional power converter in the charge-discharge circuitry as discussed herein.

It is noted that the power converter 132 may be configured as a bidirectional power converter 132-2 controlling flow of current 411 in both directions between the node N1 and the node N3. In this example, the bidirectional power converter 132-2 includes switches Q11, Q12, Q21, Q22, Q31, Q32, Q41, Q42, and transformer T41 to support the bidirectional flow of current 411 between the node N1 and the node N3.

In a similar manner as previously discussed, the controller 140-3 can be configured to generate control signals to control the switches in the power converter 132-2. For example, depending on the magnitudes of one or more voltages (such as voltages V1, V2, V3, etc.) monitored by the controller 140-3, the controller 140-3 is configured to support operational states of enabling flow of current from the node N1 to the node N3, enabling flow of current from the node N3 to the node N1, or preventing any current from flowing between the node N1 through the bidirectional power converter 132-2 and the node N3.

Any suitable conventional bidirectional power converter can be used to support the bidirectional flow of current 411 between the node N1 and the node N3.

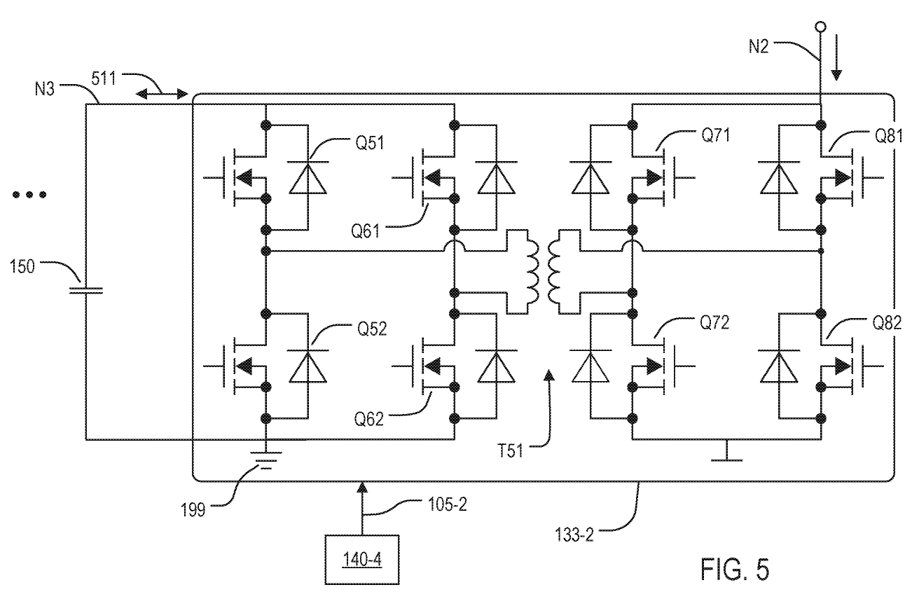

FIG. 5 is an example diagram illustrating implementation of a second bidirectional power converter in the charge-discharge circuitry as discussed herein.

It is noted that the power converter 133 may be configured as a bidirectional power converter 133-2 controlling flow of current in both directions between the node N3 and the node N2. In this example, the bidirectional power converter 132-2 includes switches Q51, Q52, Q61, Q62, Q71, Q72, Q81, Q82, and transformer T51 to support the bidirectional flow of current 511 between the node N3 and the node N2.

In a similar manner as previously discussed, the controller 140-4 can be configured to generate control signals to control the switches in the power converter 133-2. For example, depending on the magnitudes of one or more voltages (such as voltages V1, V2, V3, etc.) monitored by the controller 140-4, the controller 140-4 is configured to support operational states of enabling flow of current from the node N3 to the node N2, enabling flow of current from the node N2 to the node N3, or preventing any current from flowing between the node N3 through the bidirectional power converter 133-2 and the node N2.

Any suitable conventional bidirectional power converter can be used to support the bidirectional flow of current 511 between the node N2 and the node N3.

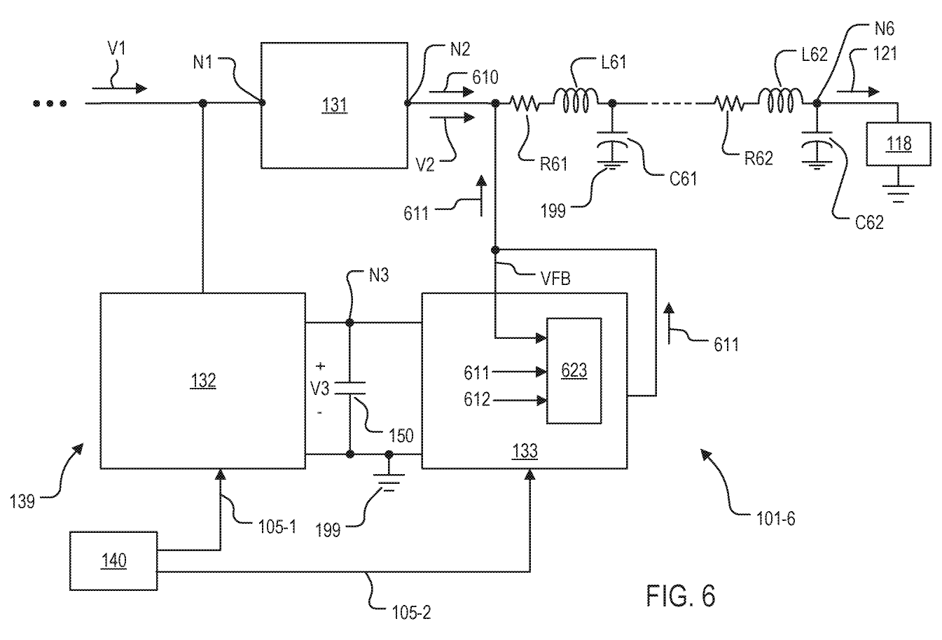

FIG. 6 is an example diagram illustrating discharge of energy stored in a capacitor bank based on feedback from a primary power converter during a transient current consumption condition by a respective load as discussed herein.

In this example, the power converter circuitry 101-6 (such as an instance of the power converter circuitry 101) includes multiple components such as controller 140, charge-discharge circuitry 139 (such as including power converter 132 and power converter 133), capacitor C2, capacitor circuitry 150 (such as a capacitor bank or other suitable energy storage resource), resistor R61, inductor L61, capacitor C61, resistor R62, inductor L62, capacitor C62, etc., and load 118.

As previously discussed, the charge-discharge circuitry 139 includes power converter 132, power converter 133, and capacitor circuitry 150. Controller 140 is in communication with the monitor circuitry 623 to receive monitor information in order to control operation of the power converter 132 and the power converter 133. It is noted that the monitor circuitry 623 may reside in the controller 140.

For example, the power converter 133 can be configured to include monitor circuitry 623 monitoring a magnitude of the voltage V2 (i.e., VFB). The monitor circuitry 623 further receives high threshold level 611 and threshold level 612 to determine whether or not to activate the power converter 132 and the power converter 133.

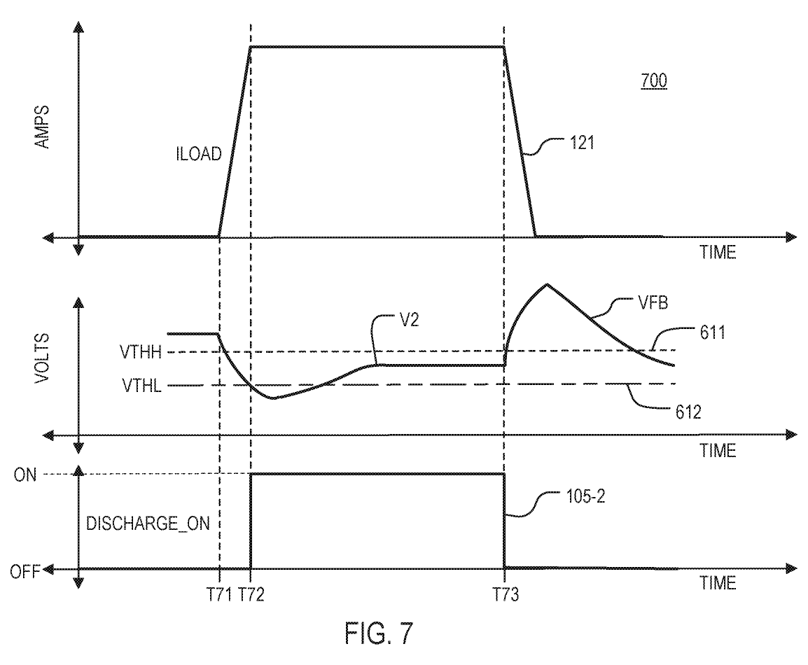

An example of controlling the charge-discharge circuitry 139 and generation of respective control signals 105-1 and 105-2 to control the respective power converter 132 and the power converter 133 based on received monitor information from the monitor circuitry 623 is further shown in FIG. 7.

FIG. 7 is an example timing diagram illustrating variation in power consumption by a respective load and activation of discharge circuitry in FIG. 6 as discussed herein.

In this example, prior to time T71, both the power converter 132 and the power converter 133 may be deactivated because the capacitor circuitry 150 is sufficiently charged with energy to a predetermined amount (such as around 65 percent of full capacity or other suitable amount) and the power converter 131 alone is able to supply sufficient power/current to power the load 118 without additional power supply from the charge-discharge circuitry 139. In such an instance, the power converter 131 supplies all of the current 121 to the load 118 and no current flows from the capacitor circuitry 150 to the node N1 or node N2.

Assume that at or around time T71, the load 118 experiences a transient condition and instantaneously consumes additional current. For example, between T71 and time T72, a magnitude of the current 121 substantially increases. As further shown, and as indicated by the feedback voltage VFB such as voltage V2 monitored by the monitor circuitry 623, the magnitude of the voltage V2 drops below the low threshold level 612 because the power converter 131 itself is unable to supply sufficient power or current to the load 118.

In response to detecting that the magnitude of the feedback voltage V2 falls below the threshold level 612 in graph 700, the controller 140 generates the control signals 105-1 to deactivate the power converter 132 and generates the control signals 105-2 to activate the power converter 133 between time T72 and time T73.

During activation of the power converter 133 between time T72 and time T73, the power converter 133 conveys supplemental current 611 from the source (capacitor circuitry 150 and corresponding node N3) and supplies it to the node N2. In such an instance, the magnitude of total current 121 supplied to the load 118 between time T72 and time T73 is a summation of the current 610 from the power converter 131 and the supplemental current 611 from the power converter 133.

As previously discussed, the controller 140 can be configured to receive a setpoint reference voltage SPRV2 associated with generation of the voltage V2. During conditions of activating the respective power converter 133 to support flow of current 611 from the capacitor circuitry 150 through the power converter 133 to the node N2, the controller 140 can be configured to regulate flow of the current 611 such that the magnitude of the voltage V2 is substantially equal to the setpoint reference voltage SPRV2.

As further shown, at or around time T73, the voltage V2 increases above the higher threshold level 611. In response to detecting this condition, the controller 140 deactivates the power converter 133 because the supplemental current 611 is no longer needed from the power converter 133.

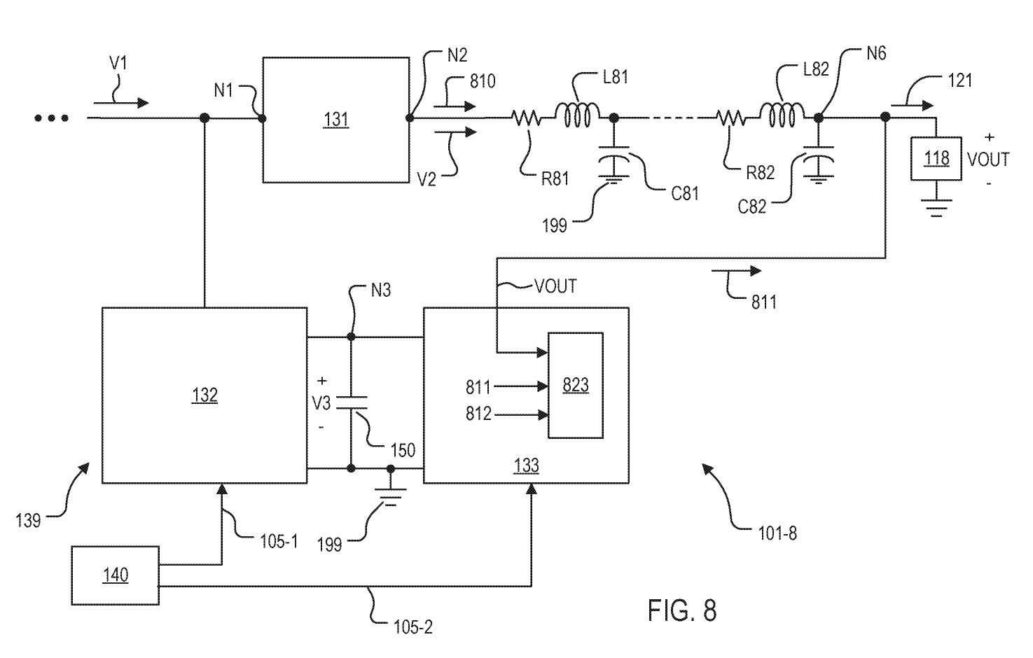

FIG. 8 is an example diagram illustrating discharge of energy stored in a capacitor bank based on feedback of supplying voltage to a load during a transient current consumption condition by the load as discussed herein.

In this example, the power converter circuitry 101-8 includes multiple components such as controller 140, charge-discharge circuitry 139 (such as including power converter 132 and power converter 133), capacitor C2, capacitor circuitry 150 (such as a capacitor bank or other suitable energy storage resource), resistor R81, inductor L81, capacitor C81, resistor R82, inductor L82, capacitor C82, etc., and load 118.

As previously discussed, the charge-discharge circuitry 139 includes power converter 132, power converter 133, and capacitor circuitry 150. Controller 140 is in communication with the monitor circuitry 823 to receive monitor information in order to control operation of the power converter 132 and the power converter 133. It is noted that the monitor circuitry 823 may be disposed in the controller 140 or any other location.

For example, the power converter 133 can be configured to include monitor circuitry 823 or other suitable entity monitoring a magnitude of the output voltage Vout via so-called remote-sensing (i.e., VFB). The monitor circuitry 823 further receives high threshold level 811 and threshold level 812 to determine whether or not to activate the power converter 132 and/or the power converter 133.

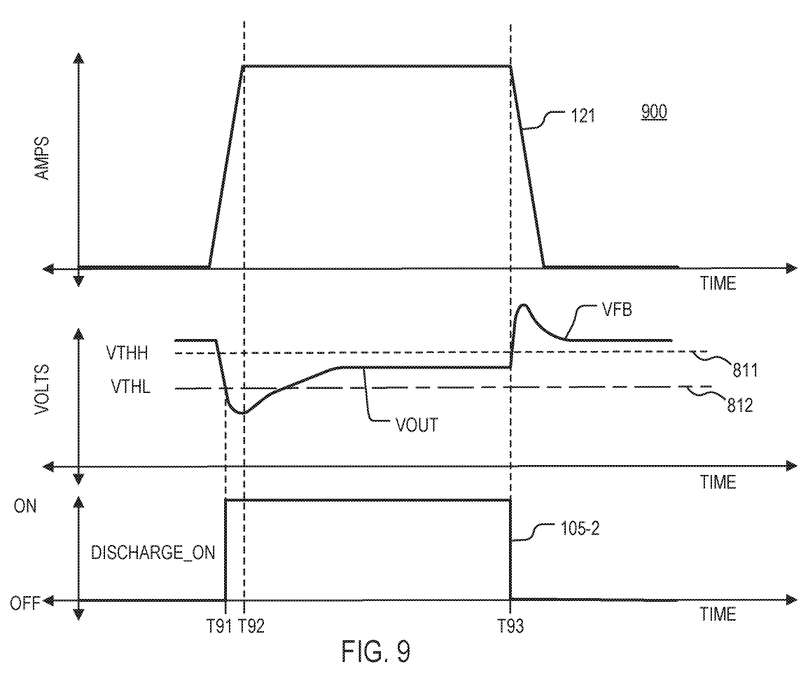

An example of controlling the charge-discharge circuitry 139 and generation of respective control signals 105-1 and 105-2 to control the power converter 132 and the power converter 133 based on received monitor information from the monitor circuitry 823 is further shown in FIG. 9.

FIG. 9 is an example timing diagram illustrating variation in power consumption by a respective load and activation of discharge circuitry in FIG. 8 as discussed herein.

In this example, prior to time T91, both the power converter 132 and the power converter 133 may be deactivated because the capacitor circuitry 150 is sufficiently charged with energy to a predetermined amount. In such an instance, the power converter 131 supplies all of the current 121 (via current 810 alone) to the load 118 and no current flows from the capacitor circuitry 150 to the node N1 or node N2.

Assume that at or around time T91, the load 118 experiences a transient condition and instantaneously consumes additional current. For example, between T91 and time T92, a magnitude of the current 121 substantially increases. As further shown, and as indicated by the feedback voltage Vout monitored by the monitor circuitry 823, the magnitude of the output voltage Vout drops below the low threshold level 812 because the power converter 131 itself is unable to supply sufficient power or current to the load 118 via the current 810 alone.

In response to detecting that the magnitude of the feedback voltage Vout falls below the threshold level 812 in graph 900, the controller 140 generates the control signals 105-1 to deactivate the power converter 132 and generates the control signals 105-2 to activate the power converter 133 between time T92 and time T93.

During activation of the power converter 133 between time T92 and time T93, the power converter 133 conveys supplemental current 811 from the source (capacitor circuitry 150 and corresponding node N3) and supplies it to the node N2, which flows downstream to the load 118. In such an instance, the current 121 supplied to the load 118 between time T92 and time T93 is a summation of the current 810 from the power converter 131 and the supplemental current 811 from the power converter 133.

The controller 140 can be configured to receive a setpoint reference voltage associated with generation of the voltage Vout. During conditions of activating the respective power converter 133 to support flow of current 811 from the capacitor circuitry 150 through the power converter 133 to the node N2, the controller 140 can be configured to regulate flow of the current 811 such that the magnitude of the voltage Vout is substantially equal to the Vout setpoint reference voltage.

As further shown, at or around time T93, the output voltage Vout increases above the higher threshold level 811. In response to detecting this condition, the controller 140 deactivates the power converter 133 because the supplemental current 811 is no longer needed from the power converter 133.

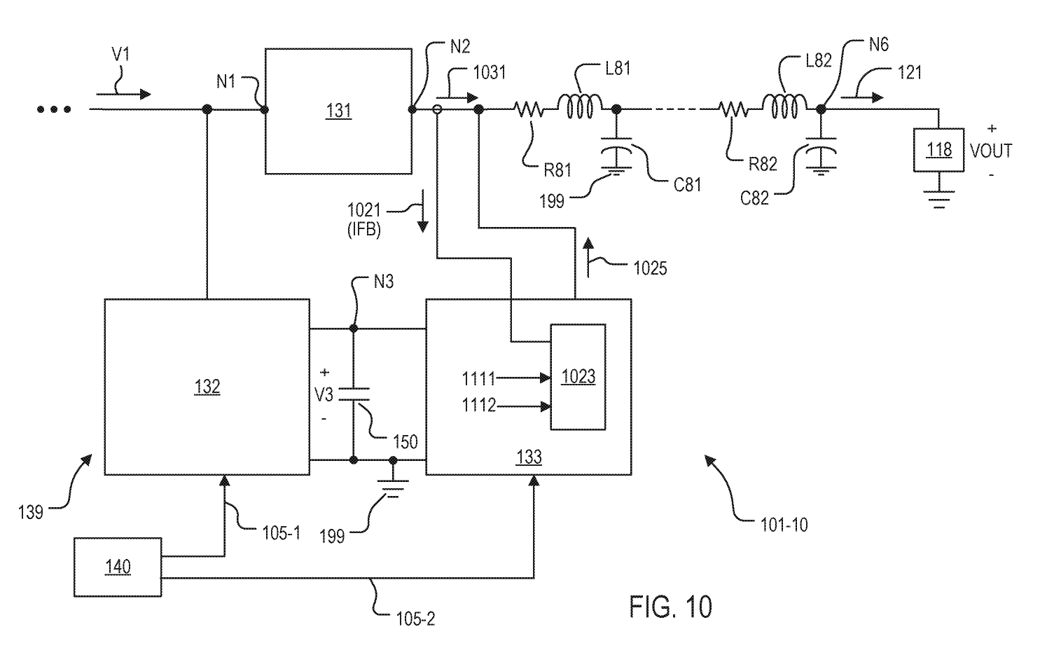

FIG. 10 is an example diagram illustrating activation of discharge circuitry during a transient power consumption condition by a load discussed herein.

In this example, the power converter circuitry 101-10 includes multiple components such as controller 140, charge-discharge circuitry 139 (such as including power converter 132 and power converter 133), capacitor C2, capacitor circuitry 150 (such as a capacitor bank or other suitable energy storage resource), resistor R81, inductor L81, capacitor C81, resistor R82, inductor L82, capacitor C82, etc., and load 118.

As previously discussed, the charge-discharge circuitry 139 includes power converter 132, power converter 133, and capacitor circuitry 150. Controller 140 is in communication with the monitor circuitry 1023 to receive monitor information in order to control operation of the power converter 132 and the power converter 133.

For example, the power converter 133 can be configured to include monitor circuitry 1023 monitoring a magnitude of the current 121 (i.e., VFB) supplied by the power converter 131 through the node N2 to the resistor R81. The monitor circuitry 1023 further receives high threshold level 1111 and threshold level 1112 to determine whether or not to activate the power converter 132 and the power converter 133. The monitor circuitry 1023 may be disposed at any location such as power converter 133 or the controller 140 or any location.

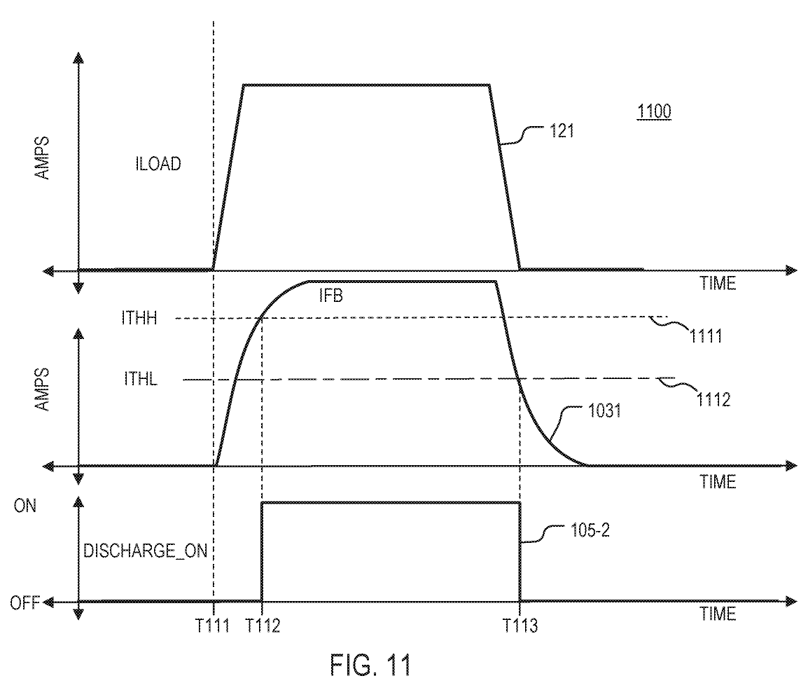

An example of controlling the charge-discharge circuitry 139 and generation of respective control signals 105-1 and 105-2 to control the power converter 132 and the power converter 133 based on the controller 140 receiving monitor information from the monitor circuitry 1023 is further shown in FIG. 11.

FIG. 11 is an example timing diagram illustrating control signals applied to discharge circuitry during the transient power consumption condition in FIG. 10 as discussed herein.

In this example, prior to time T111, both the power converter 132 and the power converter 133 may be deactivated because the capacitor circuitry 150 is sufficiently charged with energy to a predetermined amount. In such an instance, the power converter 131 supplies all of the current 121 to the load 118 and no current flows from the capacitor circuitry 150 to the node N1 or node N2.

Assume that at or around time T111, the load 118 experiences a transient condition and instantaneously consumes additional current. For example, between T111 and time T112, a magnitude of the current 121 substantially increases. As further shown, and as indicated by the feedback voltage IFB (such as one or more values indicating a magnitude of current 1031) such as monitored by the monitor circuitry 1023, the magnitude of the current 1031 rises above the threshold level 1111 because the power converter 131 itself is unable to supply sufficient power or current to the load 118.

In response to detecting that the magnitude of the feedback such as current 1031 being greater than the threshold level 1111 in graph 1100, the controller 140 generates the control signals 105-1 to deactivate the power converter 132 and generates the control signals 105-2 to activate the power converter 133 between time T112 and time T113.

During activation of the power converter 133 between time T112 and time T113, the power converter 133 conveys supplemental current 1025 from the source (capacitor circuitry 150 and corresponding node N3) and supplies it to the node N2. In such an instance, the current 121 supplied to the load 118 between time T112 and time T113 is a summation of the current 1031 from the power converter 131 and the supplemental current 1025 supplied from the power converter 133.

As further shown, at or around time T113, the magnitude of the current 121 required by the load 118 falls below the threshold level 1112. In response to detecting this condition, the controller 140 deactivates the power converter 133 because the supplemental current 1025 is no longer needed from the power converter 133.

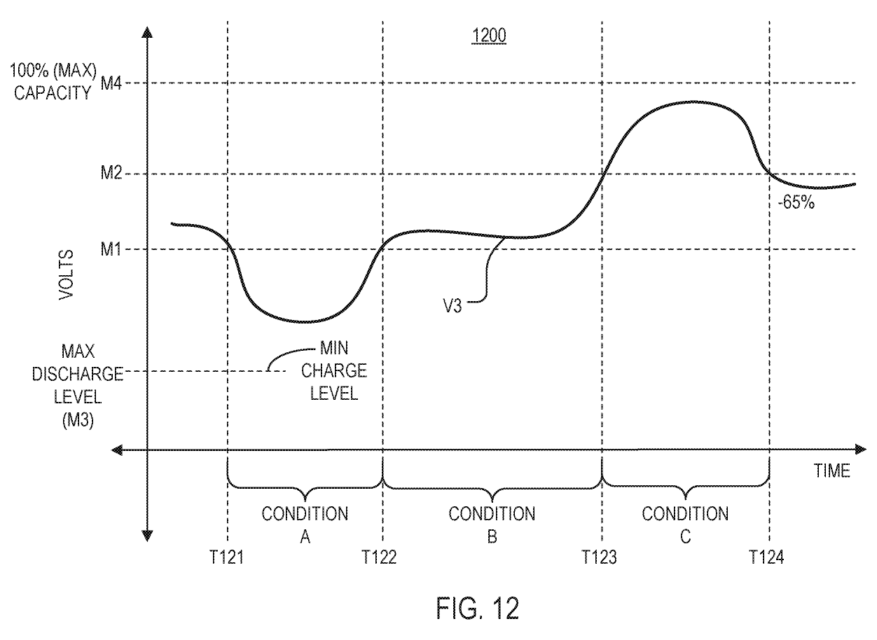

FIG. 12 is an example timing diagram illustrating different magnitudes of the voltage (power) stored in the capacitor bank over time as discussed herein.

In one implementation of the charge-discharge circuitry 139, the controller 140 or other suitable entity regulates a magnitude of the voltage V3 stored in the capacitor circuitry 150 to be approximately 65% or within a range such as between threshold level M1 (such as 60 percent of full charge capacity of the capacitor circuitry 150) and threshold level M2 (such as 70 percent of full charge capacity of the capacitor circuitry 150).

In such an instance, when the amount charge energy or voltage stored in the capacitor circuitry 150 (such as a capacitor bank of multiple capacitors) is approximately 65 percent of full charge capacity, the capacitor circuitry 150 is able to supply supplemental current through the power converter 133 to the load during conditions in which the power converter 131 is unable to supply sufficient current (power) the load 118.

Conversely, when the amount charge energy or voltage stored in the capacitor circuitry 150 (such as a capacitor bank of multiple capacitors) is approximately 65 percent of full charge capacity, the capacitor circuitry 150 is able to receive current from the node N2 through the power converter 133 during conditions in which the magnitude of the voltage V2 at node N2 is greater than a threshold level in order to reduce the voltage V2, which may cause potential damage to the load 118.

Thus, a first portion of the full charge capacity is a reserved to store sufficient charge/energy that may be used to provide supplemental current to the node N2 during conditions in which the voltage V2 is less than a first threshold level. The second portion of the full charge capacity is reserved to store supplemental current supplied from the node N2 to the node N3 during conditions in which the voltage V2 is greater than a second threshold level.

Graph 1200 of FIG. 12 illustrates the variations in the amount or magnitude of charge stored in the capacitor circuitry 150 over time.

For example, prior to time T121, such as corresponding to a steady-state condition, the capacitor circuitry 150 is charged to approximately 65 percent. Prior to time T121, the power converter 131 is able to supply sufficient power to the load 118.

Between time T121 and the time T122 during a condition such as condition A when the load 118 experiences a transient condition of requiring more current such as because the power converter 131 is unable to supply sufficient power resulting in a magnitude of the voltage V2 dropping below a threshold level, supplemental current is supplied by the capacitor circuitry 150 through the power converter 133 to maintain the voltage V2 corresponding output voltage Vout to be greater than the threshold level.

Between time T122 and the time T123 during a condition such as condition B when the power converter 131 is able to supply sufficient current to maintain a magnitude of the voltage V2 and the output voltage Vout within a desired voltage range such as above a threshold level, both of the power converter 132 and power converter 133 are deactivated. As previously discussed, the capacitor circuitry 150 stores energy such as 65 percent of full charge capacity associated with the capacitor circuitry 150. During condition B, the capacitor circuitry 150 is able to supply extra current to power the load 118 as previously discussed or the capacitor circuitry 150 is able to receive and store excess power or current from the node N2 when the voltage V2 or the output voltage Vout is above the threshold level as discussed below.

Between time T123 and the time T124 during a condition such as condition C when the load 118 experiences a transient condition of instantaneously requiring less current (less power) such as because a magnitude of the voltage V2 increases above a threshold level, the power converter 133 is activated to store the excess power supplied by the node N2 through the power converter 133 to the capacitor circuitry 150. As shown, the flow of current from the node N2 through the power converter 133 causes the magnitude of the voltage V3 to increase.

As previously discussed, subsequent to the condition C, it is desirable to maintain a magnitude of the voltage V3 such that the capacitor circuitry 150 stores approximately 65 percent of full charge capability. In such an instance, the capacitor circuitry 150 is able to supply current or receive current. Note that the condition C may include the controller 140 controlling the power converter 133 to discharge a certain amount of the charge stored in the capacitor circuitry 150 at or around time T124. In such an instance, the capacitor circuitry 150 is thereafter able to support further positive or negative transient conditions.

As further shown in graph 1200, it is desirable to maintain a magnitude of the voltage or charge in the capacitor circuitry 150 above a minimum level such as M3 to prevent damage.

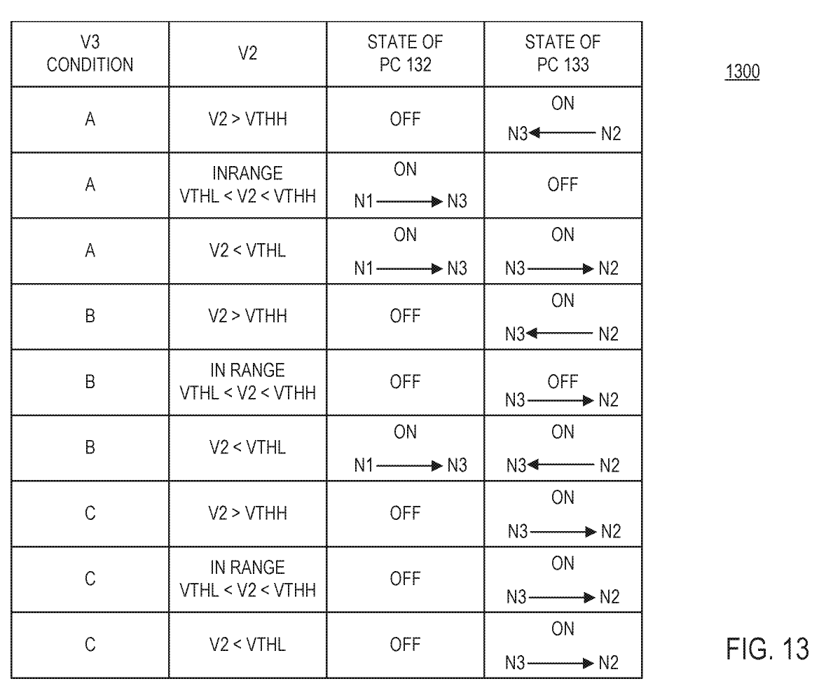

FIG. 13 is an example diagram illustrating different possible control states as implemented by the controller to control the charge-discharge circuitry as discussed herein.

In this example, the graph 1300 illustrates the different circumstances of the controller 140 controlling operation of the charge-discharge circuitry 139 to maintain a magnitude of the voltage V3 in the capacitor circuitry 150 to be within a desired voltage range such as between threshold level M1 and threshold level M2. As previously discussed, this corresponds to approximately 65 percent or other suitable amount of full charge of the capacitor circuitry 150.

### CONDITION A BETWEEN TIME T121 AND TIME T122

To determine how to control the charge-discharge circuitry 139, the controller 140 monitors multiple parameters such as including voltage V1, voltage V2, and voltage V3. Between time T121 and time T122, assume that the controller 140 detects that the voltage V3 or charge stored in the capacitor circuitry 150 is less than the threshold level M1. Assume further that the controller 140 determines that the voltage V2 is greater than a respective threshold level VTTH. In such an instance, the controller 140 deactivates the power converter 132 such that no current flows from the node N1 to the node N3. Additionally, the controller 140 activates the power converter 133 such that current flows from node N2 through the power converter 133 to the capacitor circuitry 150. This results in charging of the capacitor circuitry 150 and increasing the corresponding voltage V3. If desired, during the state when the voltage V2 is greater than the threshold level VTTH, the controller 140 can be configured to activate the power converter 132 to convey current from the capacitor circuitry 150 to the node N1. Conveyance of the current from the node N3 to the node N1 and the circumstances may include the controller 140 monitoring the voltage V1 and preventing the capacitor circuitry 150 and corresponding power converter 132 supplying so much current that the voltage V1 goes above a threshold level (SPRV1).

Further, for condition A between time T121 and time T122, assume that the controller 140 detects that the voltage V3 or charge stored in the capacitor circuitry 150 is less than the threshold level M1. Assume further that the controller 140 determines that the voltage V2 falls within a desired range such as between the threshold level VTHL and the threshold level VTHH. In such an instance, the controller 140 activates the power converter 132 such that current flows from the node N1 to the node N3. Additionally, the controller 140 deactivates the power converter 133 such that no current flows from node N2 through the power converter 133 to the capacitor circuitry 150. This control state implemented by the controller 140 results in the input node N1 charging of the capacitor circuitry 150 and increasing the corresponding voltage V3.

Further, for condition A between time T121 and time T122, assume that the controller 140 detects that the voltage V3 or charge stored in the capacitor circuitry 150 is less than the threshold level M1. Assume further that the controller 140 determines that the voltage V2 is less than a respective threshold level VTHL during condition A. In such an instance, the controller 140 activates the power converter 132 such that current flows from the node N1 to the node N3. Additionally, the controller 140 activates the power converter 133 such that current flows from node N3 and/or capacitor circuitry 150 through the power converter 133 to the node N2. This results in charging of the capacitor circuitry 150 and increasing the corresponding voltage V3 or simply passes current received from the node N1 through a combination of the power converter 132 in the power converter 133 to the node N2. In the latter instance, the charge-discharge circuitry 139 acts as a supplemental power converter disposed in parallel with the power converter 131 to provide power to the respective load 118. It is further noted that, during this condition, the controller 140 can be configured to monitor a magnitude of the voltage V1. It is desirable to activate the power converter 133 to supply current from the capacitor circuitry 150 to the node N2 to maintain a magnitude of the voltage V2. However, it may be desirable to monitor a magnitude of the voltage V1 as well to ensure that the activation of the power converter 132 does not cause an excess of draw of current on the voltage V1 so that it falls below a threshold level. Accordingly, the controller 140 can be configured to monitor the voltage V1 and control activation of the power converter 132 such that it does not cause the voltage V1 to drop below a respective threshold level (SPRV1).

### CONDITION B BETWEEN TIME T122 AND TIME T123

As previously discussed, the controller 140 monitors multiple parameters such as including voltage V2 and voltage V3 to control charging and discharging the capacitor circuitry 150. Between time T122 and time T123, assume that the controller 140 detects that the voltage V3 or charge stored in the capacitor circuitry 150 falls between the threshold level M1 and threshold level M2. Assume further that the controller 140 determines that the voltage V2 is greater than a respective threshold level VTTH. In such an instance, the controller 140 deactivates the power converter 132 such that no current flows from the node N1 to the node N3. Additionally, the controller 140 activates the power converter 133 such that current flows from node N2 through the power converter 133 to the capacitor circuitry 150. This results in charging of the capacitor circuitry 150 and increasing the corresponding voltage V3.

Further, for condition B between time T122 and time T123, assume that the controller 140 detects that the voltage V3 or charge stored in the capacitor circuitry 150 falls between the threshold level M1 and threshold level M2. Assume further that the controller 140 determines that the voltage V2 falls within a desired range such as between the threshold level VTHL and the threshold level VTHH. In such an instance, the controller 140 deactivates the power converter 132 such that no current flows from the node N1 to the node N3. Additionally, the controller 140 deactivates the power converter 133 such that no current flows from node N2 through the power converter 133 to the capacitor circuitry 150. This results in no charging or discharging of the capacitor circuitry 150.

Further, for condition B between time T122 and time T123, assume that the controller 140 detects that the voltage V3 or charge stored in the capacitor circuitry 150 falls between the threshold level M1 and threshold level M2. Assume further that the controller 140 determines that the voltage V2 is less than a respective threshold level VTHL during condition A. In such an instance, the controller 140 activates the power converter 132 such that current flows from the node N1 through the power converter 132 to the node N3 and corresponding capacitor circuitry 150. Additionally, the controller 140 activates the power converter 133 such that current flows from node N3 and/or capacitor circuitry 150 through the power converter 133 to the node N2. This results in charging of the capacitor circuitry 150 and increasing the corresponding voltage V3 or simply passing current received from the node N1 through a combination of the power converter 132 in the power converter 133 to the node N2. In the latter instance, the charge-discharge circuitry 139 acts as a supplemental power converter disposed in parallel with the power converter 131 to provide power to the respective load 118. As previously discussed, the controller 140 can be configured to regulate the power converter 132 so that it does not cause magnitude of the voltage V1 the fall below a threshold level (SPRV1).

### CONDITION C BETWEEN TIME T123 AND TIME T124

The controller 140 monitors multiple parameters such as including voltage V2 and voltage V3. For condition C, between time T123 and time T124, assume that the controller 140 detects that the voltage V3 or charge stored in the capacitor circuitry 150 is greater than the threshold level M2. Assume further that the controller 140 determines that the voltage V2 is greater than a respective threshold level VTTH. In such an instance, the controller 140 deactivates the power converter 132 such that no current flows from the node N1 to the node N3. Additionally, as long as the magnitude of the voltage V3 is less than the maximum capability and there is at least some amount of capacity of the capacitor circuitry 150 to store additional charge, the controller 140 activates the power converter 133 such that current flows from node N2 through the power converter 133 to the capacitor circuitry 150. This results in charging of the capacitor circuitry 150 and increasing the corresponding voltage V3, while decreasing magnitude of the voltage V2.

Further, for condition C, between time T123 and time T124, assume that the controller 140 detects that the voltage V3 or charge stored in the capacitor circuitry 150 is greater than the threshold level M2. Assume further that the controller 140 determines that the voltage V2 falls within a desired range such as between the threshold level VTHL and the threshold level VTHH. In such an instance, the controller 140 deactivates the power converter 132 such that no current flows from the node N1 to the node N3 (capacitor circuitry 150 is not charged). Additionally, the controller 140 activates the power converter 133 such that current flows from the capacitor circuitry 150 to the node N2. This results in discharge of the charge stored in the capacitor circuitry 150 towards the desired charge range between M1 and M2.

Further, for condition C, between time T123 and time T124, assume that the controller 140 detects that the voltage V3 or charge stored in the capacitor circuitry 150 is greater than the threshold level M2. Assume further that the controller 140 determines that the voltage V2 is less than a respective threshold level VTHL during condition A. In such an instance, the controller 140 deactivates the power converter 132 such that no current flows from the node N1 to the node N3. Additionally, the controller 140 activates the power converter 133 such that current flows from node N3 and/or capacitor circuitry 150 through the power converter 133 to the node N2. This results in discharging of the capacitor circuitry 150 and decreasing the corresponding voltage V3.

Accordingly, examples herein include:

Peak shaving Converter (such as charge-discharge circuitry 139) having a charging converter (132) and a dis-charging converter (133) and an energy reservoir (150), where the energy reservoir is series-connected between the charging and the dis-charging converter

Peak shaving Converter having a first load terminal N1 and a second load terminal N2 and an energy reservoir, wherein the Peak shaving Converter receives power from a first load terminal and delivers power to a second load terminal

Peak shaving Converter arranged in parallel to a DC/DC converter providing a parallel power path to the DC/DC converter wherein in at least one operation mode the output current of the Peak shaving converter and the output current of the parallel DC/DC converter are summing up to supply a total current total load

Peak shaving Converter having an energy reservoir connected in series between a charging and a dis-charging converter wherein the energy reservoir can be charged independently (e.g. in steady-state operation) from its discharging load profile.

Peak shaving Converter arranged in parallel with a DC/DC converter, the power flow between the two parallel converters regulated in such a way that the parallel DC/DC converter is operated in a near constant power mode removing thermal cycling stress

Peak shaving Converter having a charging converter and a dis-charging converter, where the dis-charging converter is in at least one operation mode charging the energy reservoir

Peak shaving Converter having a charging converter and a dis-charging converter, the charging converter being designed for a fraction of the power capability of the dis-charging converter.

Arrangement of a Peak shaving Converter (139) and a Intermediate Bus converter (131) in a parallel circuit, the peak shaving converter having a charging and a discharging converter, the discharging converter being dimensioned for transient high power loads and the intermediate bus converter being dimensioned for an average steady-state load.

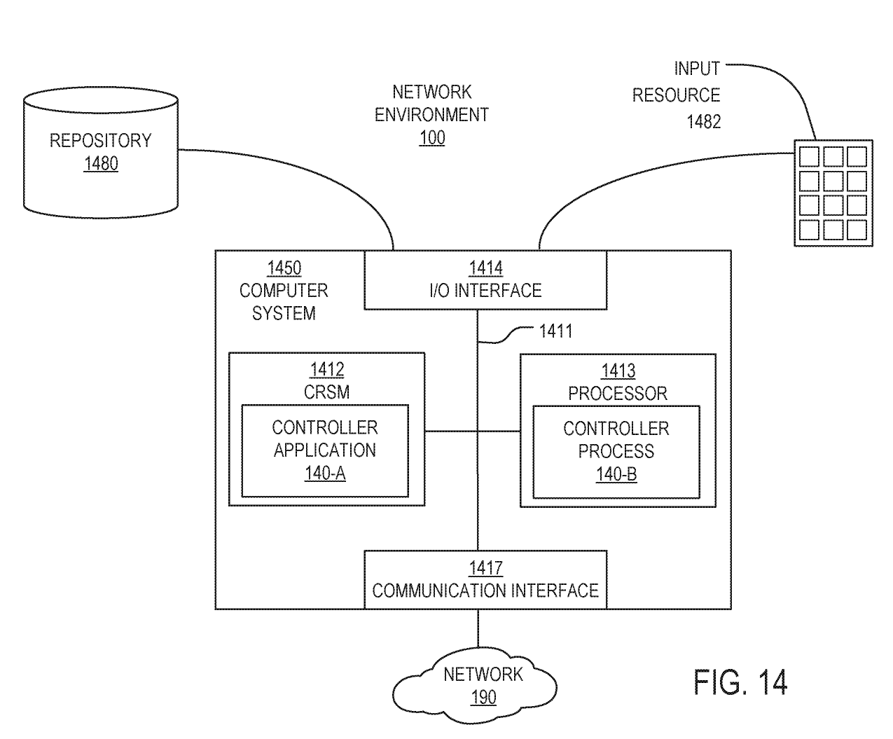

FIG. 14 is an example block diagram of a computer system for implementing any of the operations as previously discussed according to embodiments herein.

Note that any of the resources (such as controller 140, monitor circuitry, power converter, etc.) as discussed herein can be configured to include computer processor hardware, analog/digital circuitry, and/or corresponding executable instructions to carry out the different operations as discussed herein.

As shown, computer system 1450 of the present example includes an interconnect 1411 that couples computer readable storage media 1412 such as a non-transitory type of computer readable storage media or any type of hardware storage medium in which digital information can be stored and retrieved, a processor 1413, I/O interface 1414, and a communications interface 1417.

I/O interface(s) 1414 supports connectivity to repository 1480 and input resource 1492.

Computer readable storage medium 1412 (such as computer-readable storage hardware) can be any hardware storage device such as memory, optical storage, hard drive, floppy disk, etc. In one embodiment, the computer readable storage medium 1412 stores instructions and/or data.

As shown, computer readable storage media 1412 can be encoded with controller application 140-A (e.g., including instructions) to carry out any of the operations as discussed herein.

During operation of one embodiment, processor 1413 accesses computer readable storage media 1412 via the use of interconnect 1411 in order to launch, run, execute, interpret or otherwise perform the instructions in controller application 140-A stored on computer readable storage medium 1412. Execution of the controller application 140-A produces controller process 140-B to carry out any of the operations and/or processes as discussed herein.

Those skilled in the art will understand that the computer system 1450 can include other processes and/or software and hardware components, such as an operating system that controls allocation and use of hardware resources to controller application 140-A.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1450 may reside at any location or can be included in any suitable resource in any network environment to implement functionality as discussed herein.

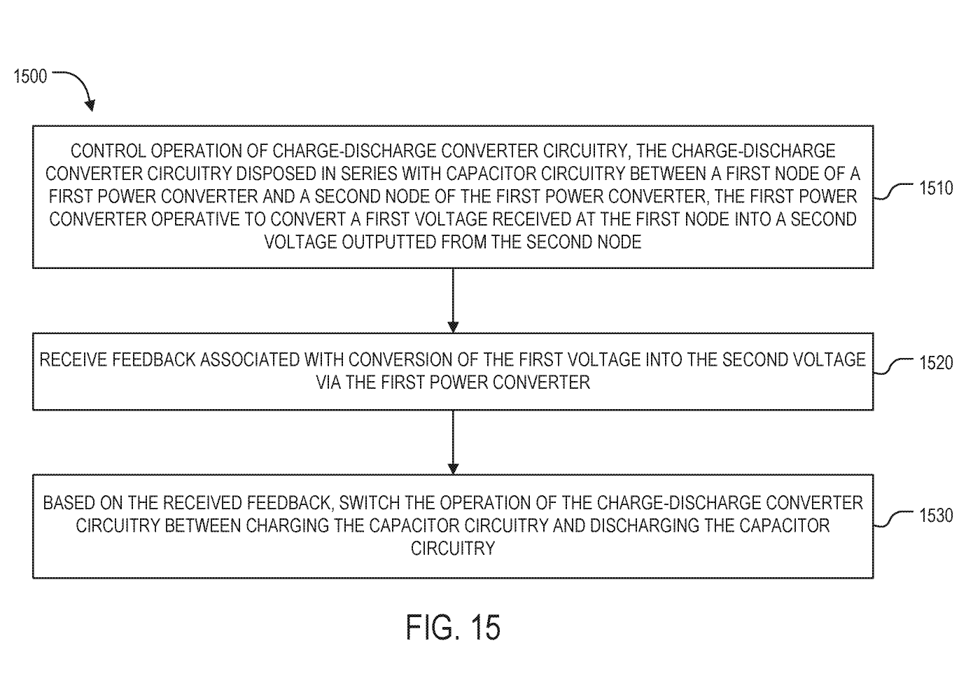

Functionality supported by the different resources will now be discussed via flowchart 1500 in FIG. 15. Note that the steps in the flowcharts below can be executed in any suitable order.

FIG. 15 is a flowchart 1500 illustrating an example method as discussed herein. Note that there will be some overlap with respect to concepts as discussed above.

In the flowchart 1500 shown in FIG. 15, in processing operation 1510, the controller 140 controls operation of charge-discharge converter circuitry 139, where the charge-discharge converter circuitry is disposed in series between a first node N1 of a first power converter 131 and a second node N2 of the first power converter 131. The first power converter 131 is operative to convert a first voltage V1 received at the first node into a second voltage V2 or Vout outputted from a second node.

In processing operation 1520, the controller 140 receives feedback associated with conversion of the first voltage into the second voltage via the first power converter.

In processing operation 1530, based on the received feedback, the controller 140 switches the operation of the charge-discharge converter circuitry between charging the capacitor circuitry and discharging the capacitor circuitry.

Note again that techniques herein are well suited for use in circuit applications such as those implementing power/energy/charge storage. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as "processing," "computing," "calculating," "determining" or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
capacitor circuitry operative to store energy;
charge-discharge converter circuitry disposed in series between a first node of a first power converter and a second node of the first power converter, the first power converter operative to convert a first voltage received at the first node into a second voltage outputted from the second node; and
a controller operative to: i) receive feedback associated with conversion of the first voltage into the second voltage via the first power converter, and ii) based on the received feedback, control operation of the charge-discharge circuitry to switch between charging the capacitor circuitry and discharging the capacitor circuitry.

2. The apparatus as in claim 1, wherein the feedback indicates a magnitude of the second voltage, the controller further operative to:
in response to detecting that the magnitude of the second voltage is less than a threshold level, control the discharge of the energy in the capacitor circuitry via enabling flow of first current from the capacitor circuitry through the charge-discharge converter circuitry to the second node of the first power converter.

3. The apparatus as in claim 2, wherein the controller is further operative to:
in response to detecting that the magnitude of the second voltage is less than a threshold level, control the charge-discharge converter circuitry to prevent flow of second current from the first node through the charge-discharge converter circuitry to the capacitor circuitry.

4. The apparatus as in claim 1, wherein the charge-discharge circuitry includes a second power converter and a third power converter disposed in series between the first node and the second node, the charge-discharge circuitry disposed in parallel with the first power converter; and
wherein a third node is configured to connect the second power converter, the third power converter, and the capacitor circuitry to each other.

5. The apparatus as in claim 4, wherein the first power converter is operative to supply non-transient power from the second node to a load during non-transient conditions of the first power converter converting the first voltage into the second voltage; and
wherein the controller is further operative to control the third power converter to supply supplemental power through the second node to the load during detected transient conditions of the first power converter producing the second voltage, the detected transient conditions including detection that a magnitude of the second voltage is less than a threshold level based on an inability of the first power converter to sufficiently power the load during the transient conditions.

6. The apparatus as in claim 1, wherein the feedback indicates a magnitude of the second voltage, the controller further operative to:
in response to detecting that the magnitude of the second voltage is less than a threshold level: i) prevent flow of first current from the first node through a first portion of the charge-discharge converter circuitry to the capacitor circuitry, and ii) discharge the energy in the capacitor through a second portion of the charge-discharge converter circuitry to the second node of the first power converter.

7. The apparatus as in claim 1, wherein the feedback indicates a magnitude of the second voltage; and
wherein the controller is further operative to: in response to detecting that the magnitude of the second voltage is greater than a threshold level: i) prevent flow of first current from the first node through a first portion of the charge-discharge converter circuitry to the capacitor circuitry, and ii) charge the capacitor circuitry via flow of second current from the second node through a second portion of the charge-discharge converter circuitry to the capacitor circuitry.

8. The apparatus as in claim 1, wherein the charge-discharge converter circuitry includes a second power converter and a third power converter disposed in series between the first node and the second node, the apparatus further comprising:
a third node directly coupling the second power converter, the third power converter, and the capacitor circuitry to each other.

9. The apparatus as in claim 8, wherein the controller is configured to implement a first peak limit of conveying power from the first node through the second power converter and the third node to the capacitor circuitry; and
wherein the controller is configured to implement a second peak limit of conveying power from the capacitor circuitry through the third node and the third power converter to the second node.

10. The apparatus as in claim 9, wherein the second peak limit is greater than the first peak limit.

11. The apparatus as in claim 1, wherein the controller is operative to control the charge-discharge converter circuitry such that: i) a first portion of a full energy storage capacity of the capacitor circuitry is reserved to store first energy received from the first node, and ii) a second portion of the full energy storage capacity of the capacitor circuitry is reserved to store second energy received from the second node.

12. The apparatus as in claim 1, wherein the energy stored in the capacitor circuitry produces a third voltage; and
wherein the controller is operative to control the charge-discharge converter circuitry to regulate a magnitude of the third voltage based on a combination of the first voltage, the second voltage, and the third voltage.

13. The apparatus as in claim 1, wherein the controller is further operative to:
for a first duration of time, in response to detecting that the magnitude of the second voltage is greater than a first threshold level, control operation of the charge-discharge converter circuitry to convey first current from the second node to the capacitor circuitry; and
for a second duration of time occurring subsequent to the first duration of time, in response to detecting that the magnitude of the second voltage is less than a second threshold level, control operation of the charge-discharge converter circuitry to convey second current from the capacitor circuitry to the second node.

14. The apparatus as in claim 1, wherein the controller is further operative to:
for a first duration of time, in response to detecting that a magnitude of the first voltage is greater than a first threshold level, control operation of the charge-discharge converter circuitry to convey first current from the first node to the capacitor circuitry; and
for a second duration of time occurring subsequent to the first duration of time, in response to detecting that the magnitude of the first voltage is less than a second threshold level, control operation of the charge-discharge converter circuitry to convey second current from the capacitor circuitry to the first node.

15. A method comprising:
controlling operation of charge-discharge converter circuitry, the charge-discharge converter circuitry disposed in series with capacitor circuitry between a first node of a first power converter and a second node of the first power converter, the first power converter operative to convert a first voltage received at the first node into a second voltage outputted from the second node;
receiving feedback associated with conversion of the first voltage into the second voltage via the first power converter; and
based on the received feedback, switching the operation of the charge-discharge converter circuitry between charging the capacitor circuitry and discharging the capacitor circuitry.

16. The method as in claim 15, wherein switching the operation of the charge-discharge converter circuitry includes:
in response to detecting that a magnitude of the second voltage is less than a first threshold level, controlling the charge-discharge converter circuitry to convey first current from the capacitor circuitry through the charge-discharge converter circuitry to the second node of the first power converter.

17. The method as in claim 16, wherein switching the operation of the charge-discharge converter circuitry includes:
in response to detecting that the magnitude of the second voltage is greater than a second threshold level, controlling the charge-discharge converter circuitry to convey second current from the second node through the charge-discharge converter circuitry to the capacitor circuitry.

18. The method as in claim 15, wherein switching the operation of the charge-discharge converter circuitry includes:
implementing a first peak limit of conveying first current from the first node through a first portion of the charge-discharge converter circuitry to the capacitor circuitry;
implementing a second peak limit of conveying second current from the capacitor circuitry through a second portion of the charge-discharge converter circuitry to the second node, the second peak limit being greater than the first peak limit.

19. The method as in claim 15, wherein the energy stored in the capacitor circuitry produces a third voltage; and
wherein switching the operation of the charge-discharge converter circuitry includes: controlling a magnitude of the third voltage based at least in part on a magnitude of the first voltage and a magnitude of the second voltage.

20. Computer-readable storage hardware having instructions stored thereon, the instructions, when carried out by computer processor hardware, cause the computer processor hardware to:
control operation of charge-discharge converter circuitry, the charge-discharge converter circuitry disposed in series between a first node of a first power converter and a second node of the first power converter, the first power converter operative to convert a first voltage received at the first node into a second voltage outputted from the second node;
receive feedback associated with conversion of the first voltage into the second voltage via the first power converter; and
based on the received feedback, switch the operation of the charge-discharge converter circuitry between charging the capacitor circuitry and discharging the capacitor circuitry.
